(19) United States
(12) Patent Application Publication
(10) Pub. No.: US 2014/0113196 A1
(43) Pub. Date: Apr. 24, 2014

(54) SYNTHESIS OF MESOPOROUS TRANSITION METAL OXIDES AS ANODE MATERIALS

(71) Applicants: Palani Balaya, Singapore (SG); Srirama Hariharan, Singapore (SG)

(72) Inventors: Palani Balaya, Singapore (SG); Srirama Hariharan, Singapore (SG)

(73) Assignee: National University of Singapore, Singapore (SG)

(21) Appl. No.: 14/128,451

(22) PCT Filed: Jun. 27, 2012
(86) PCT No.: PCT/SG2012/000226

§ 371 Date: Dec. 20, 2013

Related U.S. Application Data
(60) Provisional application No. 61/501,335, filed on Jun. 27, 2011.

(51) Int. Cl. H01M 4/52; C01G 49/06; C01G 49/08

(52) U.S. Cl. CPC H01M 4/52; C01G 49/08; C01G 49/06
USPC 429/221; 429/218.1; 423/632; 423/633; 423/634

(57) ABSTRACT

A method of preparing mesoporous nanostructured particles of a transition metal oxide. The method contains the steps of dissolving a soft-template compound in a solvent, dispersing a first or second row transition metal ion-containing compound, adjusting the pH value if necessary, and removing the solvent to obtain mesoporous nanostructured transition metal oxide powders, calcining the powders optionally to afford mesoporous nanostructured particles of the transition metal oxide. Also disclosed is particle prepared by the above-described method.

### BACKGROUND

Lithium ion batteries are essential for many energy storage applications such as in mobile power electronics and computer laptops. However, some applications, e.g., long range electric vehicles and smart grids, require lithium ion batteries with much higher energy densities than current lithium ion batteries. Energy densities can be greatly improved by using anodes that store lithium by conversion reaction instead of graphitic materials that store lithium by insertion reaction.

Transition metal oxides that store lithium by conversion reaction have very high lithium storage capacities, e.g., 2-3 times that of graphite materials. See Poizot et al., Nature, 407, 496 (2000). Yet, they often suffer from huge first cycle irreversibility, resulting in permanent impairment of capacity accompanied by poor capacity retention. So far, only RuO₂ has shown near 100% coulombic efficiency in the first cycle. See Balaya et al., Advanced Functional Materials 13, 621 (2003). However, RuO₂, being very expensive, cannot be used in commercial applications. Indeed, current processes for preparing transition metal oxides are not suitable for mass production as they suffer from low yields despite consumption of a significant amount of energy during their preparation process.

Hence, there is a need to provide inexpensive anode materials for use in lithium ion batteries.

### SUMMARY

This disclosure relates to a cost-effective method for preparing mesoporous nanostructured particles of a transition metal oxide, e.g., α-Fe₂O₃, γ-Fe₂O₃, Fe₃O₄, MoO₃, NiO, CuO, or Co₃O₄.

The method contains the steps of: (a) dissolving a soft-template compound in a solvent to obtain a soft-template solution, (b) dispersing a transition metal ion-containing compound in the soft-template solution to obtain a transition metal ion-containing mixture, (c) if necessary, adjusting the pH value of the transition metal ion-containing mixture to 2-11 (e.g., 7-11 and 8-10), (d) removing the solvent to obtain transition metal oxide powders, and (e) optionally, calcining the transition metal oxide powders at 100 to 800° C. (e.g., 150-750° C. and 200-600° C.) for a predetermined period of time (e.g., 1-12 hours and 1-6 hours) to yield mesoporous nanostructured transition metal oxide particles.

The soft-template compound can be dodecyltrimethylammonium bromide, cetyltrimethylammonium bromide, octadecyltrimethylammonium bromide, tetradecyltrimethyl-ammonium bromide, decyltrimethylammonium bromide, octyltrimethylammonium bromide, or pluronic F-127 (e.g., octyltrimethylammonium bromide, dodecyltrimethylammonium bromide, and cetyltrimethylammonium bromide); and the solvent can be a mixture of ethanol and water, in which the weight ratio of ethanol to water is 1:1 to 4:1

The transition metal ion-containing compound can be iron (II) acetate, iron (III) nitrate, iron (III) acetylacetonate, iron (II) acetylacetonate, iron (III) chloride, or iron (II) oxalate, molybdophosphoric acid, ammonium molybdate, nickel (II) acetate, nickel (II) nitrate, nickel (II) chloride, copper acetate, copper chloride, copper nitrate, cobalt acetate, cobalt nitrate, or cobalt chloride. (e.g., iron (II) acetate, iron (II) oxalate, iron (III) acetylacetonate, or iron chloride). These compounds can be provided in a powder or particulate form. Hydrates of these compounds, if available, can also be used.

The transitional metal oxide powders can be dried for 1-6 hours at 0 to 50° C. to prepare Fe₃O₄ particles, at 300 to 400° C. to prepare γ-Fe₂O₃ particles, and at 400 to 500° C. to prepare α-Fe₂O₃ particles.

Another aspect of this disclosure relates to a mesoporous nanostructured particle of a transition metal oxide prepared by the above-described process.

Still within the scope of this disclosure is a mesoporous nanostructured particle of a transition metal oxide containing a transitional metal oxide crystal and having a particle size of 3 to 200 nm and a pore size of 3 to 30 nm. The transitional metal oxide crystal can be an α-Fe₂O₃ rhombohedral crystal, a γ-Fe₂O₃ cubic spinel crystal, a Fe₃O₄ cubic spinel crystal, or a combination thereof.

The details of one or more embodiments of the disclosure are set forth in the description below. Other features, objects, and advantages of the invention will be apparent from the description and the claims.

### DETAILED DESCRIPTION

This disclosure provides a cost-effective method of preparing mesoporous nanostructured particles of a transition metal oxide, which have high lithium storage capacities and can be used as an anode material in rechargeable lithium ion batteries (LIBs) for high energy density applications.

The method includes five steps, i.e., steps (a)-(e). See the Summary section-above. Each of these steps is described in detail below.

### Step (a)

A soft-template compound is dissolved in a solvent to prepare a soft-template compound solution. The solvent can be an inorganic or organic solvent. Examples include, but are not limited to, water, methanol, ethanol, propanol, butanol, hexanol, or a combination thereof. A preferred solvent is a mixture of ethanol and water, e.g., ethanol:water being 3:1 (v/v). The soft-template compound, usually a carbon-containing surfactant, e.g., a cationic surfactant, can self-assemble into micelles at its critical micellar concentration. These micelles provide micro or meso pores for the growth of transition metal oxide nanocrystals and also restrict them from overgrowth. For examples of a soft-template compound, also see the Summary section above. The concentration of the soft-template compound in the solution can be in the range 0.008 to 2 mol/L (e.g., 0.04 to 0.16 mol/L).

### Step (b)

A transition metal ion-containing compound is dispersed in the soft-template solution obtained from step (a) to afford a transition metal ion-containing mixture. The weight ratio of the soft-template compound and the transition metal ion-containing compound is 1:1 to 2:1 (e.g., 1.3:1 to 1.9:1). The transition metal ion-containing compound can be a transition metal salt, oxide, or hydroxide. Examples include, but are not limited to, transition metal fluoride, transition metal chloride, transition metal bromide, transition metal iodide, transition metal nitrate, transition metal nitrite, transition metal sulfate, transition metal hydrogen sulfate, transition metal sulfite, transition metal bisulfite, transition metal carbonate, transition metal bicarbonate, transition metal borate, transition metal phosphate, transition metal dihydrogen phosphate, transition metal hydrogen ammonium phosphate, transition metal silicate, transition metal antimonate, transition metal arsenate, transition metal germanate, transition metal oxide, transition, metal alkoxide, transition metal enolate, transition metal phenoxide, transition metal hydroxide, a transition metal salt with a carboxylic acid (e.g., acetate and oxalate) or a hydroxyl carboxylic acid (e.g., glycolate, lactate, citrate, and tartrate), and a combination thereof. The transition metal refers to any transition metal shown in the periodic table, preferably one of the first and second row transition metals; more preferably, iron, molybdenum, nickel, copper, or cobalt; and most preferably, iron.

Note that each of the transition metal ions in these compounds may have an oxidation state that is different from that required of the transition metal oxide product. Oxidizing or reducing conditions can be applied to bring the oxidation state of the starting ions to that required of the final product. For example, the soft-template reaction can be carried out in a reducing atmosphere such as hydrogen, ammonia, and methane. See Balaya et al., WO 2012/023904.

Turning to the transition metal ion-containing mixture, it can be a solution or a slurry. Preferably, it is a solution in which all the compounds are dissolved in a solvent. When the mixture is a slurry, it is preferred that the compound is homogenously dispersed in a solvent. To achieve complete dissolution or homogenous dispersion of the compounds, one can use both physical and chemical means, including milling, spraying, shaking, high shear mixing, sonicating, condensing, and chemical reactions.

### Step (c)

If necessary, the pH value of the transition metal ion-containing mixture is adjusted to 2-11 that allows formation of transition metal oxide nanocrystals. The pH value can be adjusted by adding to the mixture a buffer solution, an acid or a base (e.g., hydrochloric acid, sulphuric acid, ammonium hydroxide or sodium hydroxide).

In general, the resulting mixture can be stirred at the room temperature or at an elevated temperature for an adequate amount of time. Without being bound by any theory, the mechanism for forming the nanocrystals is described in the International Patent Application Publication WO 2012/023904 (Balaya et al.)

### Step (d)

The solvent is removed (e.g., by evaporation at an elevated temperature, by filtration, and by centrifugation) from the mixture provided in step (c) or (b) to obtain mesoporous nanostructured transition metal oxide powders or precursors containing nanocrystals that are formed either in step (b) by stirring the mixture, in step (c) by adjusting the pH value of the mixture, or in this step by removing the solvent. The powder or precursor can be further dried under vacuum. For example, Fe₃O₄ cubic spinel crystals are conveniently obtained by removing the solvent from the iron ion-containing mixture by drying in vacuum.

### Step (e)

If necessary, the mesoporous nanostructured transition metal oxide powders thus obtained are calcined at 100-800° C. for a predetermined period of time, e.g., 1-12 hours. For example, α-Fe₂O₃ rhombohedral crystals are obtained by calcining the mesoporous nanostructured Fe₃O₄ powders at 400-550° C. and γ-Fe₂O₃ cubic spinel crystals are obtained by calcining the same powders at 300-400° C.

A person skilled in the art can determine without undue experimentation the types and amounts of solvent, the transition metal ion-containing compound, as well as other conditions such as soft-template compound concentration and calcination time.

The specific examples below are to be construed as merely illustrative, and not limitative of the remainder of the disclosure in any way whatsoever. Without further elaboration, it is believed that one skilled in the art can, based on the description herein, utilize the present invention to its fullest extent. All publications cited herein are incorporated by reference in their entirety.

### Example 1

### Preparation of Mesoporous Nanostructured Fe₃O₄, α-Fe₂O₃, and γ-Fe₂O₃ Particles

Mesoporous nanostructured Fe₃O₄, α-Fe₂O₃, and γ-Fe₂O₃ particles were synthesized using the simple gram-scale soft-template method described above. Cetyltrimethylammonium bromide (CTAB, 3.6-7.2 grams) was first dissolved in a mixture of 120-240 ml of water and ethanol (1:1 to 3:1 volume ratio). Iron (II) acetate (2-4 grams) dispersed in the above CTAB solution. The pH of the solution was adjusted to 8-10 with ammonium hydroxide. The solution was stirred for 24-48 hours, followed by rotoevaporation or centrifugation to remove the solvent. The resulting precipitate was then vacuum-dried to obtain magnetite, Fe₃O₄. Further calcination of magnetite in air for 2-6 hours resulted in formation of γ.Fe₂O₃ at 300-380° C. and of α-Fe₂O₃ at 420-550° C.

### Example 2

### Characterization of Mesoporous Nanostructured Fe₃O₄, α-Fe₂O₃, and γ-Fe₂O₃ Particles

Powder X-ray diffraction (XRD) studies were conducted on the products prepared in Example 1.

The XRD patterns show pure phases of Fe₃O₄, γ-Fe₂O₃ and α-Fe₂O₃ in the respective products. For referencing the peaks, JCPDS card No. 8800315, JCPDS card No. 39-1346 and JCPDS card No 33-0664 were used respectively.

In addition to the XRD characterization, the products were also viewed under a field emission scanning electron microscope (FESEM). The particle sizes of the product were summarized in Table 1 below.

TABLE 1
Size and morphology of the various iron
oxides produced by soft-template approach

| | Particle size | | |
|---|---|---|---|
| Phase of iron oxide | Range (nm) | | Morphology |
| Magnetite, Fe₃O₄ | 5-7 | nm | Irregular spheres |
| Maghemite, γ-Fe₂O₃ | 5-15 | nm | Self assembled spheres |
| Hematite, α-Fe₂O₃ | 10-100 | nm | Elongated dumb-bell |
| | | | shaped particles |

### Example 4

### Electrochemical Storage Performance of Mesoporous Nanostructured Fe₃O₄, α-Fe₂O₃, and γ-Fe₂O₃ Particles

In order to gauge the electrochemical storage performance of mesoporous nanostructured Fe₃O₄, α-Fe₂O₃, and γ-Fe₂O₃ particles, coin type half cells were assembled. The electrodes consisted of at least 75% by weight the Fe₃O₄, α-Fe₂O₃, or γ-Fe₂O₃ particles. Additionally, the conductive carbon additive 15% by weight and a polyvinylidene fluoride-based binder 10% by weight were present. The electrodes were heated to 150-350° C. in an inert atmosphere for 2-12 hours prior to the cell assembly. The electrolyte was 1 mol LiPF₆ in the mixture of ethylene carbonate and diethyl carbonate (1:1, v/v). Test cells were cycled between the voltage 0.04V-3V at different current rates (0.1-5 C).

For example, the half cell made from Fe₂O₃ (calcined at 420-550° C. for 2-6 hours) against Li metal was tested at a current rate of 0.1 C. The first cycle discharge capacity was 1320-1350 mAhg⁻¹, which is above the theoretical capacity (1005 mAhg⁻¹). The first cycle charge capacity was 1171-1222 mAhg⁻¹, representing a very high coulombic efficiency of 89-90%. Further, to test the storage performance at high current rates, the cells were cycled at 1 C to 5 C. Unexpectedly, even at 5 C (12 min of charge/discharge), the cells still retain capacities in excess of 400 mAhg⁻¹ with flat voltage profile during charge and discharge. The stable cyclability of the cells over a period of 60 cycles (10 cycles at each current density) shows that the material remains well integrated during the course of cycling.

In addition, full cells using spinel or olivine type cathodes (e.g., LiMn₂O₄ and LiMn₁₋ₓFeₓPO₄) and one of the iron oxides as anodes were fabricated. The active material weights in the cathode and anode were balanced to match the difference in the capacities. The full cells demonstrated a stable cyclability, e.g., reversible charge and discharge capacities of 75-80 mAhg⁻¹ and 60-65 mAhg⁻¹, respectively.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

1. A process of preparing mesoporous nanostructured particles of a transition metal oxide, the method comprising:
dissolving a soft-template compound in a solvent to obtain a soft-template solution,
dispersing a transition metal ion-containing compound in the soft-template solution to obtain a transition metal ion-containing mixture,
adjusting the pH value of the transition metal ion-containing mixture to 2-11, if necessary, and
removing the solvent to obtain mesoporous nanostructured transition metal oxide powders.

2. The process of claim 1, wherein the transition metal oxide is α-Fe₂O₃, γ-Fe₂O₃, Fe₃O₄, MoO₃, NiO, CuO, or CO₃O₄.

3. The process of claim 1, further comprising calcining the nanostructured transition metal oxide powders at 100 to 800° C. for a sufficient period of time to yield mesoporous nanostructured transition metal oxide particles.

4. The process of claim 1, wherein the transition metal oxide is α-Fe₂O₃, γ-Fe₂O₃, or Fe₃O₄.

5. The process of claim 4, wherein the soft-template compound is dodecyltrimethylammonium bromide, cetyltrimethylammonium bromide, octadecyltrimethylammonium bromide, tetradecyltrimethylammonium bromide, decyltrimethylammonium bromide, octyltrimethylammonium bromide, or pluronic F-127; the transition metal ion-containing compound is iron (II) acetate, iron (III) nitrate, iron (III) acetylacetonate, iron (III) chloride, or iron (II) oxalate; and the solvent is a mixture of ethanol and water, in which the weight ratio of ethanol to water is 1:1 to 4:1; and if necessary, the pH value of the iron ion-containing mixture is adjusted to 7-11.

6. The process of claim 5, wherein the soft-template compound is octyl trimethylammonium bromide, dodecyltrimethyl ammonium bromide, or cetyltrimethylammonium bromide; the transition metal ion-containing compound is iron (II) acetate, iron (II) oxalate, iron (III) acetylacetonate, or iron chloride, the weight ratio of ethanol to water is 1:1 to 3:1; and if necessary, the pH value is adjusted to 8-10.

7. The process of claim 4, wherein the transition metal oxide is Fe₃O₄.

8. The process of claim 7, wherein the soft-template compound is octyltrimethylammonium bromide, decyltrimethylammonium bromide, dodecyltrimethylammonium bromide, tetradecyltrimethylammonium bromide, cetyltrimethylammonium bromide, octadecyltrimethylammonium bromide, or pluronic F-127; the transition metal ion-containing compound is iron (II) acetate, iron (III) nitrate, iron (III) acetylacetonate, iron (III) chloride, or iron (II) oxalate; and the solvent is a mixture of ethanol and water, in which the weight ratio of ethanol to water is 1:1 to 4:1; and if necessary, the pH value of the iron ion-containing mixture is adjusted to 7-11.

9. The process of claim 8, wherein the soft-template compound is octyltrimethylammonium bromide, dodecyltrimethyl ammonium bromide, or cetyltrimethylammonium bromide; the transition metal ion-containing compound is iron (II) acetate, iron (II) oxalate, iron (III) acetylacetonate or iron chloride; the weight ratio of ethanol to water is 1:1 to 3:1; and if necessary, the pH value is adjusted to 8-10.

10. The process of claim 4, further comprising calcining the nanostructured transition metal oxide powders at 400 to 550° C. for 1 to 6 hours to yield mesoporous nanostructured transition metal oxide particles.

11. The process of claim 10, wherein the soft-template compound is octyltrimethylammonium bromide, decyltrimethylammonium bromide, dodecyltrimethylammonium bromide, tetradecyltrimethylammonium bromide, cetyltrimethylammonium bromide, octadecyltrimethylammonium bromide, or pluronic F-127; the transition metal ion-containing compound is iron (II) acetate, iron (III) nitrate, iron (III) acetylacetonate, iron (III) chloride, or iron (II) oxalate; and the solvent is a mixture of ethanol and water, in which the weight ratio of ethanol to water is 1:1 to 4:1; and if necessary, the pH value of the iron ion-containing mixture is adjusted to 7-11.

12. The process of claim 11, wherein the soft-template compound is octyltrimethylammonium bromide, dodecyltrimethyl ammonium bromide, or cetyltrimethylammonium bromide; the transition metal ion-containing compound is iron (II) acetate, iron (II) oxalate, iron (III) acetylacetonate or iron chloride; the weight ratio of ethanol to water is 1:1-3:1; and if necessary, the pH value is adjusted to 8-10.

13. The process of claim 4, further comprising calcining the nanostructured transition metal oxide powders at 300 to 400° C. for 1 to 6 hours to yield mesoporous nanostructured transition metal oxide particles.

14. The process of claim 13, wherein the soft-template compound is octyltrimethylammonium bromide, decyltrimethylammonium bromide, dodecyltrimethylammonium bromide, tetradecyltrimethylammonium bromide, cetyltrimethylammonium bromide, octadecyltrimethylammonium bromide, or pluronic F-127; the transition metal ion-containing compound is iron (II) acetate, iron (III) nitrate, iron (III) acetylacetonate, iron (III) chloride, or iron (II) oxalate; and the solvent is a mixture of ethanol and water, in which the weight ratio of ethanol to water is 1:1 to 4:1; and if necessary, the pH value of the iron ion-containing mixture is adjusted to 7-11.

15. The process of claim 14, wherein the soft-template compound is octyltrimethylammonium bromide, dodecyltrimethyl ammonium bromide, or cetyltrimethylammonium bromide; the transition metal ion-containing compound is iron (II) acetate, iron (II) oxalate, iron (III) acetylacetonate, or iron chloride, the weight ratio of ethanol to water is 1:1-3:1; and if necessary, the pH value of the iron ion-containing mixture is adjusted to 8-10.

16. The process of claim 1, wherein the soft-template compound is octyltrimethylammonium bromide, decyltrimethylammonium bromide, dodecyltrimethylammonium bromide, tetradecyltrimethylammonium bromide, cetyltrimethylammonium bromide, octadecyltrimethylammonium bromide, or pluronic F-127; and the solvent is a mixture of ethanol and water, in which the weight ratio of ethanol to water is 1:1 to 4:1.

17. The process of claim 16, further comprising calcining the nanostructured transition metal oxide powders at 100 to 800° C. for a sufficient period of time to yield mesoporous nanostructured transition metal oxide particles, wherein the transition metal oxide is MoO₃, NiO, CuO, or Co₃O₄; the transition metal ion-containing compound is molybdophosphoric acid, ammonium molybdate, nickel acetate, nickel nitrate, nickel chloride, copper acetate, copper nitrate, copper chloride, cobalt acetate, cobalt nitrate, or cobalt chloride.

18. The process of claim 17, wherein the transition metal oxide powders are calcined at 150 to 750° C. for 1 to 6 hours.

19. The process of claim 18, wherein the transition metal oxide powders are calcined at 200 to 600° C.

20-26. (canceled)

27. A mesoporous nanostructured transition metal oxide particle prepared by the process of claim 1.

28. A mesoporous nanostructured transition metal oxide particle comprising a transition metal oxide crystal, wherein the particle has a particle size of 3 to 200 nm and a pore size of 3 to 30 nm.

29. The particle of claim 28, wherein the transition metal oxide crystal is an α-Fe₂O₃ rhombohedral crystal, a γ-Fe₂O₃ cubic spinel crystal, a Fe₃O₄ cubic spinel crystal, or a combination thereof.
